(19) United States
(12) Patent Application Publication
(10) Pub. No.: US 2024/0126368 A1
(43) Pub. Date: Apr. 18, 2024

(54) INTERFERENCE PATTERN DETECTION FOR EYE TRACKING IN A HEAD-MOUNTED DEVICE

(71) Applicant: Meta Platforms Technologies, LLC, Menlo Park, CA (US)

(72) Inventors: Mantas Zurauskas, Redmond, WA (US); James Schloss, Lake Stevens, WA (US); Pavel Trochtchanovitch, Shoreline, WA (US)

(21) Appl. No.: 18/369,096

(22) Filed: Sep. 15, 2023

Related U.S. Application Data
(60) Provisional application No. 63/415,397, filed on Oct. 12, 2022.

(51) Int. Cl. G06F 3/01

(52) U.S. Cl. CPC G06F 3/013

(57) ABSTRACT

An eye tracking system for a head-mounted devices includes an interference pattern emitter, an interference pattern detector, and processing logic. The interference pattern emitter provides at least two light beams that combine into a light pattern in an eyebox region of the head-mounted device. The light pattern includes an interference pattern based on constructive and destructive interference of the at least two light beams. The light detector is configured to detect a portion of the light pattern and provides detector data that is representative of one or more light intensities in the portion of the light pattern. The processing logic is coupled to the light detector to receive the detector data and is configured to identify displacement characteristics of the interference pattern. The processing logic is configured to determine orientation characteristics of an eye in the eyebox region based on the displacement characteristics.

### CROSS-REFERENCE TO RELATED APPLICATIONS

This application claims priority to U.S. provisional Application No. 63/415,397 filed Oct. 12, 2022, which is hereby incorporated by reference.

### TECHNICAL FIELD

This disclosure relates generally to eye tracking, and in particular to interference pattern detection for eye position sensing.

### BACKGROUND INFORMATION

Various techniques exist for determining an eye orientation. However, current approaches for determining eye orientation have deficiencies when it comes to determining eye orientation for eye tracking operations.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a block diagram of a head-mounted device configured to use interference pattern detection for eye tracking, in accordance with aspects of the disclosure.

FIG. 2 illustrates a perspective view of an example of a head-mounted device, in accordance with aspects of the disclosure.

FIGS. 3A, 3B, 3C, 3D, 3E, and 3F illustrate various aspects of interference patterns and interference pattern detectors, in accordance with aspects of the disclosure.

FIGS. 4A and 4B illustrate example diagrams of implementations of an interference pattern detector, in accordance with aspects of the disclosure.

FIG. 5 illustrates an example diagram of a side view of an eye tracking system, in accordance with aspects of the disclosure.

FIGS. 6A, 6B, 6C, 6D, and 6E illustrate example diagrams of potential implementations of an interference pattern emitter, in accordance with aspects of the disclosure.

FIG. 7 illustrates a flow diagram of a process for determining eye position with a head-mounted device, in accordance with aspects of the disclosure.

FIG. 8 illustrates a flow diagram of a process for determining eye position with a head-mounted device, in accordance with aspects of the disclosure.

### DETAILED DESCRIPTION

Embodiments of interference pattern detection for eye tracking in a head-mounted device are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Glints are reflections off of a cornea that are commonly used for eye tracking. In many common implementations, the eye is illuminated with a point source, and an image of an eye is recorded with a camera. The recorded image is processed to identify the position (centroid) of the glint. The change of the glint position is proportional to the gaze direction. However, this camera-based approach is bandwidth intensive because determination of each eye position requires capturing a full frame.

Alternatively, a camera can be replaced with a photodetector that detects a glint and tracks a gaze angle based on the change of amplitude of the detected signal. The intensity of the recorded signal is different for different eye positions. The drawback of this approach is that intensity measurements suffer from crosstalk of reflected and scattered light. Also, the changes of back-reflected light as a function of gaze are very weak for small eye displacements.

Disclosed herein is a new approach to eye tracking where the eye is illuminated with one or more coherent light sources that generate interference patterns that are detected either with de-focused camera or with photodetector arrays. The disclosed detection technique amplifies the signal change because the light field at the sensing plane is no longer uniform but has rapidly varying sinusoidal intensity or polarization modulation, in accordance with aspects of the disclosure.

Disclosed are systems and methods of interference pattern detection for eye tracking in a head-mounted device. The disclosed systems and methods may offer several advantages over existing eye tracking techniques. For example, using several photodiodes to detect an interference pattern is a cost-efficient implementation of eye orientation or motion detection. The disclosed photodiode-based detection technique may provide relatively high-accuracy detection, with arcmins-level (e.g., less than 6 arcmins) resolution, according to an embodiment. Regarding speed of reading, photodiodes can be configured to allow 1 to 100 kHz readouts, according to an embodiment. Determining or reading a relative eye orientation (rather than an absolution orientation) may provide accurate and fast estimations of gaze vector change. A frequency chirp-based solution may also be configured to provide absolute gaze, according to some embodiments.

An eye tracking system for a head-mounted devices includes an interference pattern emitter, an interference pattern detector, and processing logic, according to an embodiment. The interference pattern emitter may provide at least two light beams that combine into a light pattern in an eyebox region of the head-mounted device. The light pattern may include an interference pattern based on constructive and destructive interference of the at least two light beams. The light detector is configured to detect a portion of the light pattern and provides detector data that is representative of one or more light intensities in the portion of the light pattern. The processing logic is coupled to the light detector to receive the detector data and is configured to identify displacement characteristics (e.g., distance of displacement, rate of displacement, and/or direction of displacement) of the interference pattern. The processing logic is configured to determine orientation characteristics (e.g., relative or absolute position, angle of rotation, angular rate of rotation) of an eye in the eyebox region based on the displacement characteristics. In one embodiment, processing logic counts a number of periods in the phase shift (e.g., shift/displacement of bands of light of fringe pattern) of an interference pattern to determine displacement or displacement characteristics of the interference pattern.

The interference pattern emitter may be implemented using a variety of configurations. For example, the interference pattern emitter may be implemented with a single light source optically coupled to a diffractive optical element to provide the interference pattern. The diffractive optical element may be a phase grating, a spatial light modulator, or some other optical element. The diffractive optical element may be configured to emit light beams at one or more angles to add or further define spatial carrier frequencies in the interference pattern.

The interference pattern detector may be implemented using a variety of configurations. The interference pattern detector may include a single photodiode, a one-dimensional (1D) photodiode array, a two-dimensional (2D) photodiode array, or an image sensor. The interference pattern detector may include readout circuitry configured to convert photodiode signals (e.g., voltages or currents) into detection data that can be provided to processing logic.

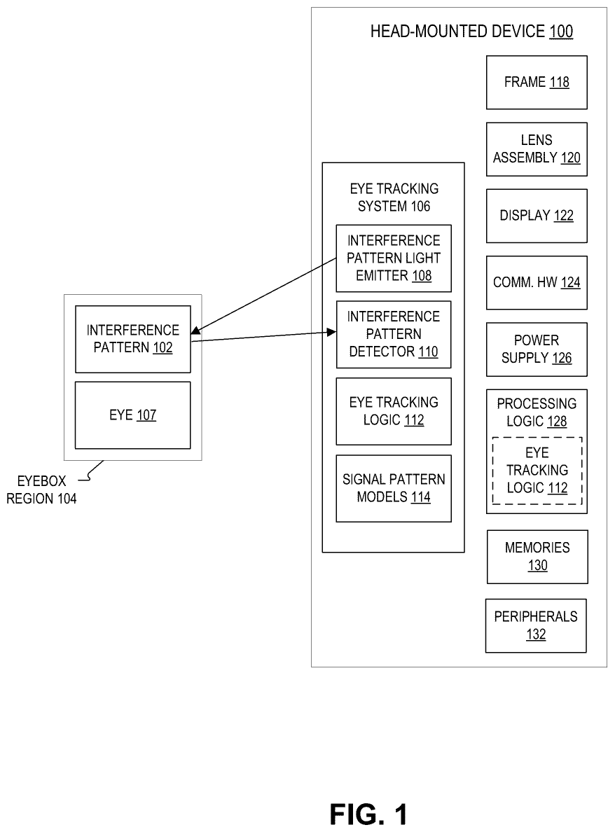

The apparatus, system, and method for interference pattern detection for eye tracking in a head-mounted device that are described in this disclosure include improvements in determining eye orientation and/or relative eye position, which may be used to support eye tracking operations in a head-mounted device. These and other embodiments are described in more detail in connection with FIGS. 1-8.

FIG. 1 illustrates a block diagram of a head-mounted device 100 that is configured to use interference pattern detection for eye tracking, in accordance with aspects of the disclosure. Head-mounted device 100 provides an interference pattern 102 to illuminate an eyebox region 104 to enable an eye tracking system 106 to use one or more of a variety of techniques to determine an orientation or position of an eye 107 in eyebox region 104. Eye tracking system 106 may be configured to perform eye tracking operations based on the orientation or position of eye 107 that is within eyebox region 104, according to an embodiment. A head-mounted device, such as head-mounted device 100, is one type of smart device. In some contexts, head-mounted device 100 is also a head-mounted display (HMD) that is configured to provide artificial reality. Artificial reality is a form of reality that has been adjusted in some manner before presentation to the user, which may include, e.g., virtual reality (VR), augmented reality (AR), mixed reality (MR), hybrid reality, or some combination and/or derivative thereof.

Eye tracking system 106 includes a number of components that are configured to support eye tracking operations, in accordance with aspects of the disclosure. Eye tracking system 106 may include an interference pattern emitter 108, an interference pattern detector 110, eye tracking logic 112, and signal pattern models 114, according to an embodiment. Interference pattern emitter 108 is configured to provide interference pattern 102 onto at least part of eyebox region 104, according to an embodiment. For example, interference pattern 102 may be emitted and/or constructed to change sinusoidally in intensity in at least one direction. Interference pattern 102 may be observed as a fringe pattern having bright bands of light (constructive interference) interlaced with dark bands of light (destructive interference). Interference pattern 102 may be emitted and/or constructed to change sinusoidally in intensity in two directions (e.g., orthogonally from each other) to enable eye position detection in multiple directions, according to an embodiment. A multi-directional version of interference pattern 102 may include bright bands of light and dark bands of light oriented in different directions, and the multi-directional interference pattern may be observed as a grid pattern having shapes (e.g., ovals, circles, squares) that vary in intensity based on the combined interference of two, three, four, or more individual interference patterns, for example.

Interference pattern emitter 108 emits two or more light beams to generate interference pattern 102, in accordance with aspects of the disclosure. Interference pattern emitter 108 may include one or more coherent light sources, diffraction gratings, splitters, fiber optics or other optical elements to cause two or more light beams to interfere in eyebox region 104. Interference pattern emitter 108 may emit light with wavelengths in the near-infrared spectrum or in another non-visible band of light. Interference pattern emitter 108 may include one or more light sources that may include one or more of light emitting diodes (LEDs), photonic integrated circuit (PIC) based illuminators, micro light emitting diode (micro-LED), an edge emitting LED, a superluminescent diode (SLED), a vertical cavity surface emitting laser (VCSEL), or another type of laser.

Eye tracking system 106 may use interference pattern detector 110 to detect reflection of interference pattern 102 from eyebox region 104, in accordance with aspects of the disclosure. Interference pattern detector 110 may be implemented as a single photodiode, as a one-dimensional (1D) array of photodiodes, as a two-dimensional (2D) array of photodiodes, or as an image sensor, according to various embodiments. Interference pattern detector 110 may be implemented as various types of image sensors, such as a complementary metal-oxide semiconductor (CMOS) image sensor, a light field sensor, or an event camera. Interference pattern detector 110 may be configured to be responsive to light that is not in the visible spectrum (e.g., light in the near-infrared spectrum). Interference pattern detector 110 may include one or more filters (e.g., bandpass filters, high-pass filters, etc.) configured to enable interference pattern detector 110 to detect light in the near-infrared spectrum or in another non-visible band of light. Interference pattern detector 110 may be oriented toward eyebox region 104 to detect (e.g., capture images of) reflections of interference pattern 102 off of eye 107 while positioned within eyebox region 104. Interference pattern detector 110 may generate detector data (e.g., intensity signals, voltage or current changes, image data) representing one or more characteristics or displacement characteristics of interference pattern 102, as detected from eyebox region 104. Displacement characteristics of the interference pattern may include: a displacement distance of the interference pattern, a distance displacement rate of the interference pattern, or displacement direction (e.g., left, right, up, down, etc.). The detector data may be analyzed by eye tracking system 106 to determine orientation characteristics (e.g., a relative or absolute orientation or a position) of eye 107 of a user.

Eye tracking logic 112 is configured to operate interference pattern emitter 108 and interference pattern detector 110 to determine an eye orientation or position within eyebox region 104, in accordance with aspects of the disclosure. Eye tracking logic 112 may be communicatively coupled to interference pattern emitter 108 and to interference pattern detector 110, according to an embodiment. Eye tracking logic 112 may be configured to selectively operate interference pattern emitter 108 to support one or more operations of head-mounted device 100. For example, eye tracking logic 112 may be configured to operate interference pattern emitter 108 to determine an eye orientation to support AR or VR display operations, in an embodiment. Eye tracking logic 112 may receive detector data from interference pattern detector 110 and may be configured to perform one or more signal or image analysis operations on the detector data to determine one or more characteristics (e.g., a rate of movement, change in position, direction of movement) of eye 107 in eyebox region 104. In one embodiment, eye tracking logic 112 may use one or more signal pattern models 114 to determine an orientation of an eye. For example, signal pattern models 114 may include one or more machine learning models, one or more predictive models, or additional analytics that provide an indication of orientation based on the detector data. Eye tracking logic 112 may additionally or alternatively perform one or more mathematical operations (e.g., Fourier transform, inverse Fourier transform, centroid identification, etc.) on the detector data that represents detection or image capture of interference pattern 102, according to various embodiments. In one embodiment, eye tracking logic 112 counts a number of periods in the phase shift (e.g., shift/displacement of bands of light of fringe pattern) of interference pattern 102 to determine displacement or displacement characteristics of interference pattern 102.

In addition to eye tracking system 106, head-mounted device 100 includes a frame 118, a lens assembly 120, a display 122, communications hardware 124, a power supply 126, processing logic 128, one or more memories 130, and peripherals 132, in accordance with aspects of the disclosure. Frame 118 may be configured to be worn on or about a head of user and is configured to carry the various components of head-mounted device 100, according to an embodiment. Lens assembly 120 may include one or more optical layers (e.g., prescription layer, display layer, illumination layer, etc.) to provide external scene light and display light to eyebox region 104. Lens assembly 120 may be coupled to frame 118 around, for example, a periphery of lens assembly 120. Display 122 may include a waveguide or other optical element that is configured to direct display light (e.g., user interface elements) towards eyebox region 104 to augment a user's interaction with digital content. Communications hardware 124 may include various antennas, chips, or other hardware to support communications using, for example, Wi-Fi, Bluetooth, near-field communications, ethernet, USB, or other communications protocols between head-mounted device 100 and peripheral computing devices. Power supply 126 may include a battery, wired power, or wireless power to provide power to the various components of head-mounted device 100, according to an embodiment.

Processing logic 128 is communicatively coupled to eye tracking system 106, display 122, and communications hardware 124 to operate head-mounted device 100, according to an embodiment. Processing logic 128 may be configured to at least partially control eye tracking system 106. Processing logic 128 may include eye tracking logic 112 and may be configured to provide information (e.g., user experience buttons, text, graphics, and/or other elements) to display 122 based on orientation characteristics (e.g., a relative or absolute orientation) of eye 107. Processing logic 128 may include circuitry, logic, instructions stored in a machine-readable storage medium, ASIC circuitry, FPGA circuitry, and/or one or more processors. Processing logic 128 may be coupled to one or more memories 130 (e.g., volatile and/or non-volatile) to perform one or more (computer-readable) instructions stored on memories 130.

Processing logic 128 may be configured to receive information from and be configured to control one or more peripherals 132. Processing logic 128 may be configured to control peripherals 132 at least partially based on an eye orientation determined with eye tracking system 106, according to an embodiment. Peripherals 132 may include a microphone, a speaker, and haptics (e.g., vibration) sensors to support a user's interactive experience with head-mounted device 100.

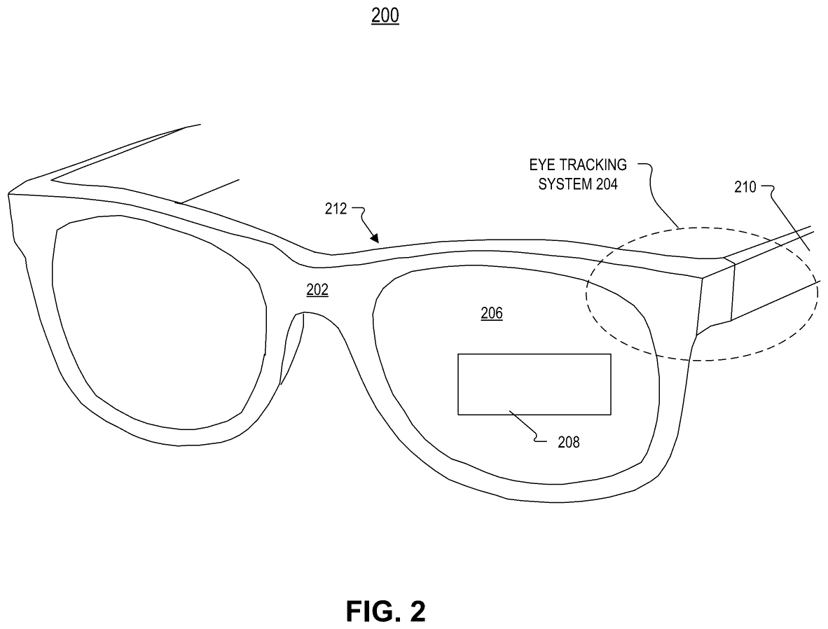

FIG. 2 illustrates a perspective view of an example of a head-mounted device 200, in accordance with aspects of the disclosure. Head-mounted device 200 is an example implementation of head-mounted device 100 (shown in FIG. 1). Head-mounted device 200 may include a frame 202, an eye tracking system 204, a lens assembly 206, and a display 208, in accordance with aspects of the disclosure. Frame 202 is an illustrative example of frame 118 (shown in FIG. 1). Eye tracking system 204 may be implemented into various locations of frame 202, such as within an arm 210 or a front portion 212 of frame 202. For example, portions of an interference pattern emitter and/or interference pattern detector may be incorporated into arm 210 and/or into the top, side, middle, or bottom of front portion 212. Lens assembly 206 is an example implementation of lens assembly 120 (shown in FIG. 1). The interference pattern emitter and/or the interference pattern detector may be at least partially integrated into lens assembly 206, according to an embodiment. Display 208 is an example implementation of display 122 (shown in FIG. 1) and may be integrated into or positioned onto lens assembly 206. Display 208 may be integrated into a display layer of a stack of optical layers that define lens assembly 206.

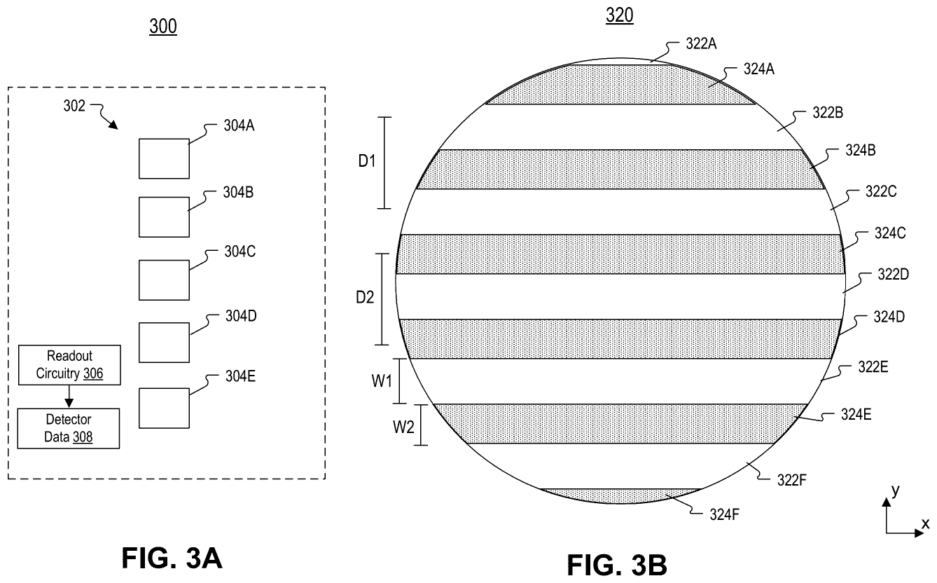

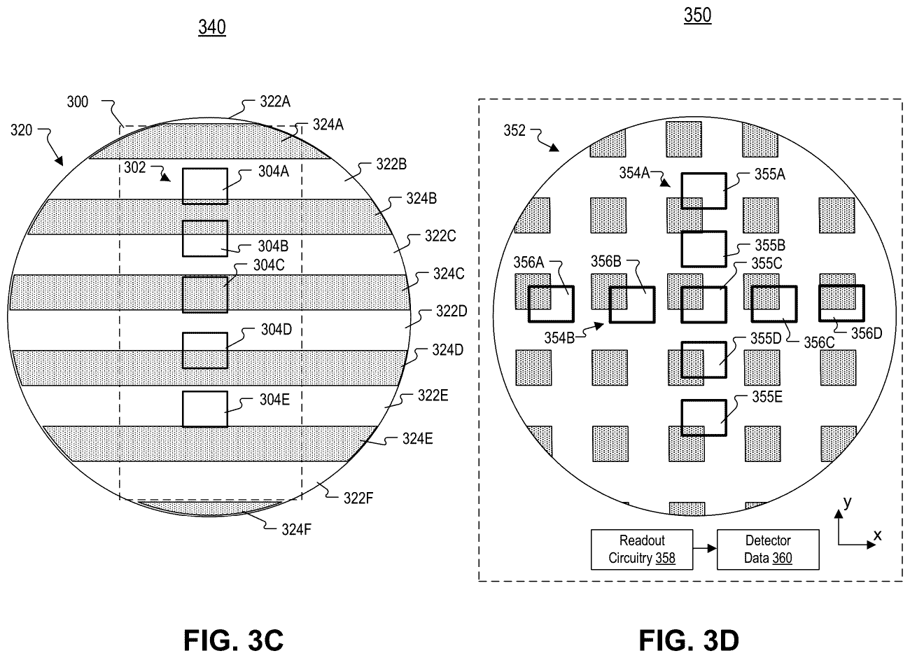

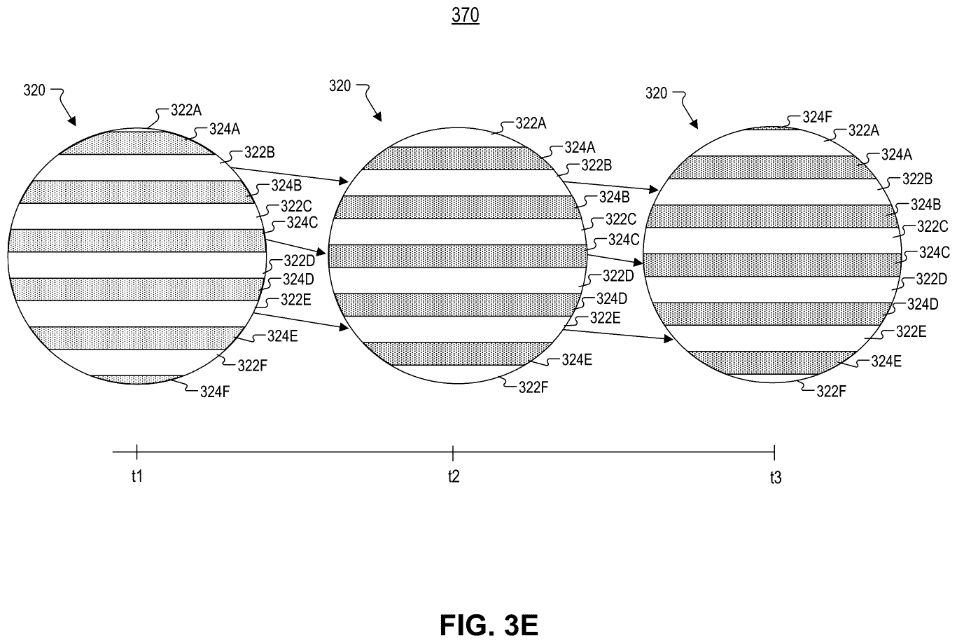

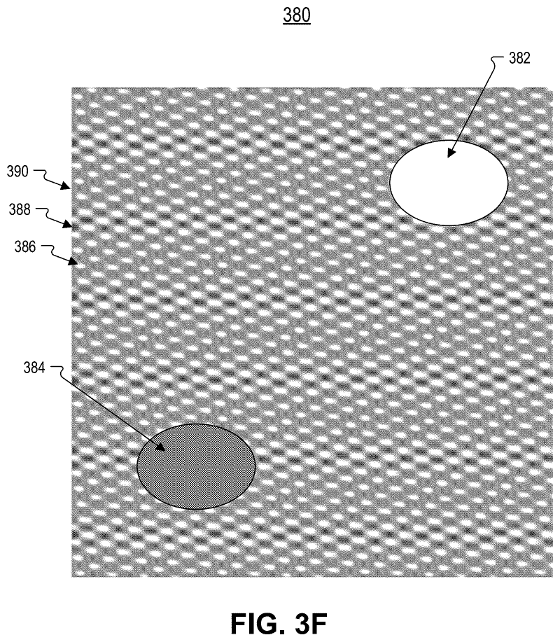

FIGS. 3A, 3B, 3C, 3D, 3E, and 3F illustrate various aspects of interference patterns and interference pattern detectors, in accordance with aspects of the disclosure.

FIG. 3A illustrates a diagram of an interference pattern detector 300, in accordance with aspects of the disclosure. Interference pattern detector 300 includes a photodiode array 302 and is an example implementation of interference pattern detector 110 (shown in FIG. 1), according to an embodiment. Photodiode array 302 may include a number of photodiodes 304 (individually, photodiode 304A, 304B, 304C, 304D, and 304E) arranged in a column, row, diagonal or other 1D structure. Interference pattern detector 300 may also include readout circuitry 306 coupled to photodiode array 302. Readout circuitry 306 may be configured to level-shift voltages from photodiodes 304, may be configured to convert analog or digital measurements into bytes of representative detector data, and/or may be configured to interface with processing logic of a head-mounted device to provide detector data 308, according to various embodiments.

FIG. 3B illustrates a diagram of an example of an interference pattern 320 that interference pattern detector 300 may be configured to detect, in accordance with aspects of the disclosure. Interference pattern 320 may be generated by an interference pattern emitter and is representative of constructive and destructive interference of light beams, according to an embodiment. Interference pattern 320 may include a number of light bands that are representative of constructive and destructive interference of light beams. Interference pattern 320 may be observed as a circular, rectangular, oval, or square shaped glint of light (e.g., when observed with a focused image sensor or camera). When observed with a de-focused image sensor, for example, light bands may be observable as interference pattern 320. Bright bands of light 322 may include a number of individual bright bands of light 322A, 322B, 322C, 322D, 322E, and 322F, for example. Although six example bright bands of light 322 are illustrated and specifically referenced, interference pattern 320 may include more or less bright bands of light 322. Dark bands of light 324 may include a number of individual dark bands of light 324A, 324B, 324C, 324D, 324E, and 324F, for example. Dark bands of light 324 may be interleaved with bright bands of light 322 as a sinusoidal (e.g., oscillating) function of intensity with respect to a particular direction or axis (e.g., a y-axis). Although bright bands of light 322 and dark bands of light 324 are illustrated (for simplicity) as having a uniform intensity, in practice, bright bands of light 322 gradually decrease in intensity until becoming dark bands of light 324, and vice-versa, according to an embodiment.

Interference pattern 320 may have a spatial frequency (i.e., a repeating period along the y-axis) that is at least partially defined by the interference pattern emitter, according to an embodiment. For example, the frequency of light emitted, the distance between interfering light beams, the exit angle of the light beams from the emitter, and/or the distance between the interference pattern emitter and the eyebox region may define the distance D1 (e.g., the period) between bright bands of light 322 and the distance D2 between dark bands of light 324, according to an embodiment. The distances D1 and D2 may be the same and may define the spatial frequency of bright bands of light 322 and/or dark bands of light 324. The frequency of light emitted, the distance between interfering light beams, and/or the distance between the interference pattern emitter and the eyebox region may also at least partially define a width W1 of each of bright bands of light 322 and define a width W2 of each of dark bands of light 324, according to an embodiment.

FIG. 3C illustrates a diagram 340 of interference pattern 320 overlaying interference pattern detector 300, as may occur in the implementation of eye tracking system 106, in accordance with aspects of the disclosure. In operation, individual ones of the photodiodes 304 detect light and dark aspects of bands of light 322 and 324. When an eye changes position (e.g., rotates right, left, up, or down), bands of light 322 and 324 shift (e.g., shift up/down or left/right). When bands of light 322 and 324 shift (e.g., shift up), bright bands of light 322 and dark bands of light 324 traverse across photodiodes 304. The traversing bands of light 322 and 324 cause photodiodes 304 to sequentially turn on and off. More specifically, as a bright band of light 322E becomes incident upon photodiode 304E, photodiode 304E turns on and indicates the detection of a bright band of light, and as a dark band of light 324D traverses across photodiode 304D, photodiode 304D turns off, according to an embodiment. Each time a photodiode turns off can be counted as a period of phase shifting of an interference pattern, or each time a photodiode turns on can be counted as a period of phase shifting of an interference pattern, according to an embodiment. Photodiodes 304 may be selected to have a particular sensitivity so that a photodiode turns on when, for example, at least ⅓ of the photodiode is illuminated by one of bright bands of light 322. Similarly or alternatively, photodiodes 304 may be selected to have a light sensitivity so that a photodiode turns off when, for example, at least ½ of the photodiode is covered by one of dark bands of light 324. Detector data 308 may be representative of voltage or current measurements of photodiodes 304 as bands of light 322 and 324 are stationary upon or traversing across photodiodes 304, according to an embodiment. In one embodiment, a rate (e.g., microns per second) at which bands of light 322 and 324 traverse one or more photodiodes 304 is used by, for example, processing logic to determine a rate of movement (e.g., degrees per second) of a user's eye in the eyebox region. In one embodiment, a duration of bands of light 322 and 324 traversing one or more photodiodes 304 is used by, for example, processing logic to determine a relative change in position of an eye in the eyebox region.

FIG. 3D illustrates a diagram 350 of a two-dimensional (2D) interference pattern 352 overlaying a 2D interference pattern detector 354, in accordance with aspects of the disclosure. 2D interference pattern 352 is an example illustration of an interference pattern of three or more (e.g., four) light beams interfering constructively and destructively in an eyebox region. 2D interference pattern 352 may be generated by concurrently emitting a first 1D interference pattern (e.g., interference pattern 320) orthogonally to a second 1D interference pattern, for example. The first and second 1D interference patterns may be rotated with respect to each other at an angle other than 90° (e.g., at 45°, 110°, etc.), according to one embodiment.

2D interference pattern detector 354 may include a 1D photodetector array 354A and a 1D photodetector array 354B that are configured to detect bands of light moving in two directions, according to an embodiment. 1D photodetector array 354A may include a number of photodetectors 355A, 355B, 355C, 355D, and 355E organized in a row, column, or other line. 1D photodetector array 354B may include a number of photodetectors 356A, 356B, 355C, 356C, and 356D organized in a row, column, or line. 1D photodetector array 354A may be oriented orthogonally to 1D photodetector array 354B, according to one embodiment. 1D photodetector array 354A may be rotated with respect to 1D photodetector array 354B at an angle other than 90° (e.g., at 45°, 110°, etc.), according to one embodiment. 1D photodetector array 354A may be configured to detect traversing bands of light in a first direction (e.g., along the y-axis) and 1D photodetector array 354B may be configured to detect bands of light traversing in a second direction (e.g., along the x-axis), according to an embodiment. Readout circuitry 358 may be configured to generate detector data 360 that is representative of the detection of 2D interference pattern 352 traversing in one or more directions, according to an embodiment. Processing logic may be coupled to readout circuitry 358 to receive detector data 360. Processing logic may be configured to determine a relative eye orientation and/or an eye motion rate using the detector data 360, according to an embodiment.

FIG. 3E illustrates a timing diagram 370 of bright bands of light 322 and dark bands of light 324 shifting or rotating across interference pattern 320, in accordance with aspects of the disclosure. Timing diagram 370 illustrates how bands of light 322 and 324 might traverse across a photodiode array in response to an orientation/position change of an eye in an eyebox region, according to an embodiment. Between a first time t1 and a second time t2, bright band of light 322A becomes larger as it shifts down and more fully into interference pattern 320, and dark band of light 324F transitions down and out of interference pattern 320, for example. Between second time t2 and a third time t3, a new dark band of light 324F appears at the top of interference pattern 320 and other bands of light 322 and 324 transition further downward in interference pattern 320, for example. Bands of light 322 and 324 may shift up, down, quickly, and slowly, based on the motion of the eye and/or based on characteristics of the interference pattern emitter, according to an embodiment. If the eye in the eyebox region is stationary, interference pattern 320 remains stationary as well, in an embodiment.

FIG. 3F illustrates an example diagram of a 2D interference pattern 380 having identifiable artifacts 382 and 384, in accordance with aspects of the disclosure. 2D interference pattern 380 may include a number of bright spots 386 (e.g., from constructive interference), a number of dark spots 388 (e.g., from destructive interference), and a number of grey areas 390 that are indicative of combined light intensity that is between bright and dark. An image of artifacts 382 and 384 may be used by processing logic of a head-mounted device to identify an absolute orientation of an eye by, for example, associating particular locations of artifacts 382 and 384 with particular orientations of an eye in an eyebox region (e.g., using a lookup table, a predictive/analytical model, machine learning, etc.). Artifact 382 may be a region in 2D interference pattern 380 that has an average intensity that is greater/brighter than the surrounding regions, and artifact 384 may be a region in 2D interference pattern 380 that has an average intensity that is lower/darker than the surrounding regions, for example. Artifacts 382 and 384 may alternatively be generated as one or more particular sub-patterns within 2D interference pattern 380 that enables processing logic to (e.g., uniquely) identify a particular region or regions of 2D interference pattern 380 reflected from a surface of an eye, according to an embodiment.

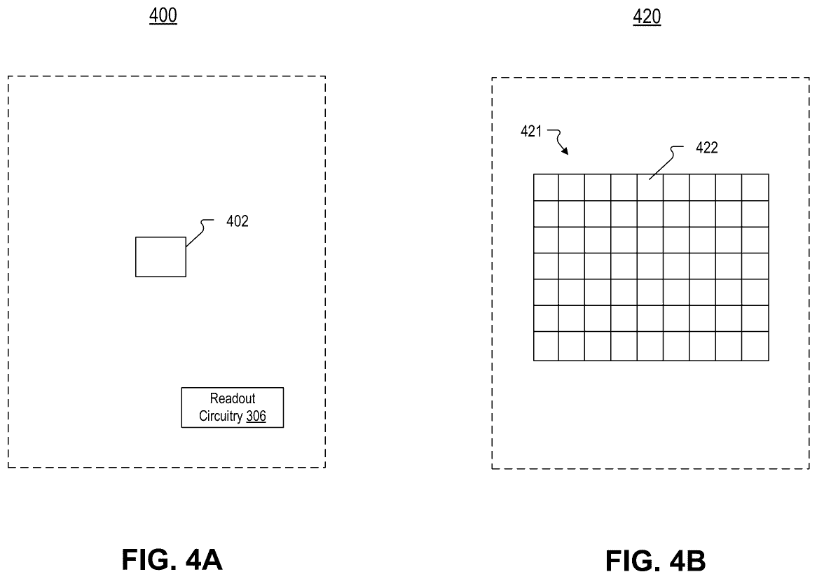

FIGS. 4A and 4B illustrate example diagrams of implementations of an interference pattern detector, in accordance with aspects of the disclosure. FIG. 4A illustrates a diagram of an interference pattern detector 400, in accordance with aspects of the disclosure. Interference pattern detector 400 includes readout circuitry 306 and a single photodiode 402, according to an embodiment. FIG. 4B illustrates a diagram of an interference pattern detector 420, in accordance with aspects of the disclosure. Interference pattern detector 420 is implemented using an image sensor 421 having a number of pixels 422 organized into rows and columns, according to an embodiment. Image sensor 421 may include integrated readout circuitry configured to provide detector data that includes image data of, for example, an interference pattern. If focused upon with a lens, an interference pattern may appear as a glint to an image sensor, but if the image sensor 421 (or a lens) is de-focused, the fringe bands of the interference pattern may be captured by interference pattern detector 420, according to an embodiment.

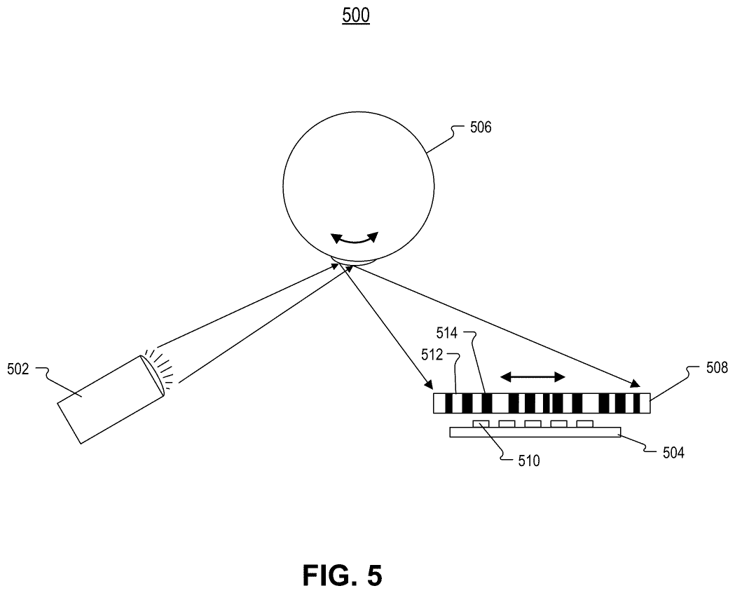

FIG. 5 illustrates an example diagram of a side view of an eye tracking system 500, in accordance with aspects of the disclosure. Eye tracking system 500 is an example implementation of eye tracking system 106 (shown in FIG. 1), according to an embodiment. Eye tracking system 500 includes an interference pattern emitter 502 and an interference pattern detector 504, according to an embodiment. Interference pattern emitter 502 may be configured to illuminate eye 506 with an interference pattern 508. Reflections of interference pattern 508 are received and detected by interference pattern detector 504, according to an embodiment. Interference pattern detector 504 may include a number of photodiodes 510 that operate (e.g., turn on or off) in response to bright bands of light 512 and dark bands of light 514 of interference pattern 508, according to an embodiment. Bands of light 512 and 514 may shift (e.g., left and right) within interference pattern 508 in response to eye 506 rotating side to side, up and down, or a combination of horizontal and vertical rotation. Bands of light 512 and 514 may have uniform widths or may have varying widths (as illustrated).

Eye tracking system 500 may offer several advantages over existing eye tracking techniques. For example, using several photodiodes per field point is a cost-efficient implementation of eye orientation or motion detection. The disclosed photodiode-based detection technique may provide relatively high-accuracy, with arcmins-level (e.g., less than 6 arcmins) resolution, according to an embodiment. Regarding speed of reading, photodiodes can be configured to allow 1 to 100 kHz readouts, according to an embodiment. Determining or reading a relative eye orientation (rather than an absolution orientation) may provide accurate and fast estimations of gaze vector change. Frequency chirp-based solution may also be configured to provide absolute gaze, according to some embodiments.

Eye tracking system 500 may enable high-precision eye tracking, according to embodiments of the disclosure. Illumination with coherent sources can generate periodic patterns at the detection plane (e.g., the interference pattern detector) that move at high speeds in response to eye movement. This permits high-precision eye tracking. The interference pattern can be sinusoidal to detect the gaze change in one direction. The interference pattern can be chirped (or otherwise engineered for custom unambiguous modulation). Frequency components (e.g., intentional artifacts) can be engineered to enable sensing of absolute eye position. Two orthogonal sinusoidal patterns can detect the gaze direction in two directions (e.g., along the x and y axes) to more fully enable gaze tracking. Custom 2D patterns containing two or more fundamental frequencies can also be used, according to some embodiments. An interference pattern emitter may be configured to modulate the intensity, polarization, and/or wavelength of light beams to encode the interference patterns with additional information. In the case of polarization or wavelength modulation, heterodyne detection can be used to separate multiple illumination sources and to increase the signal-to-noise ratio (SNR) of interference patterns and the encoded additional information. Temporal heterodyne detection can be implemented for SNR improvement purposes and may be enabled by projecting a sequence of patterns that changes in time. The emitter may be one of several emitters, and the one or more emitters may be selectively turned on in sequence to, for example, encode the interference pattern with additional decodable information.

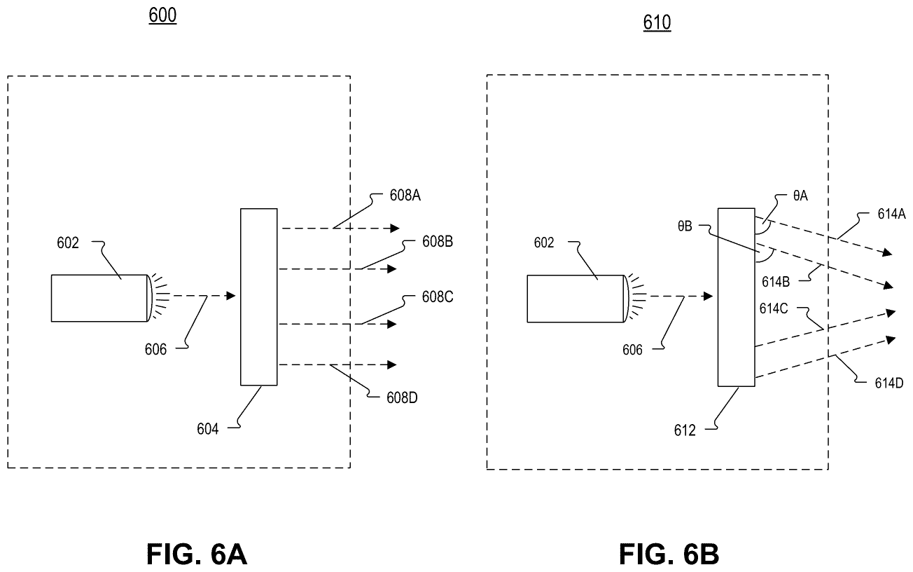

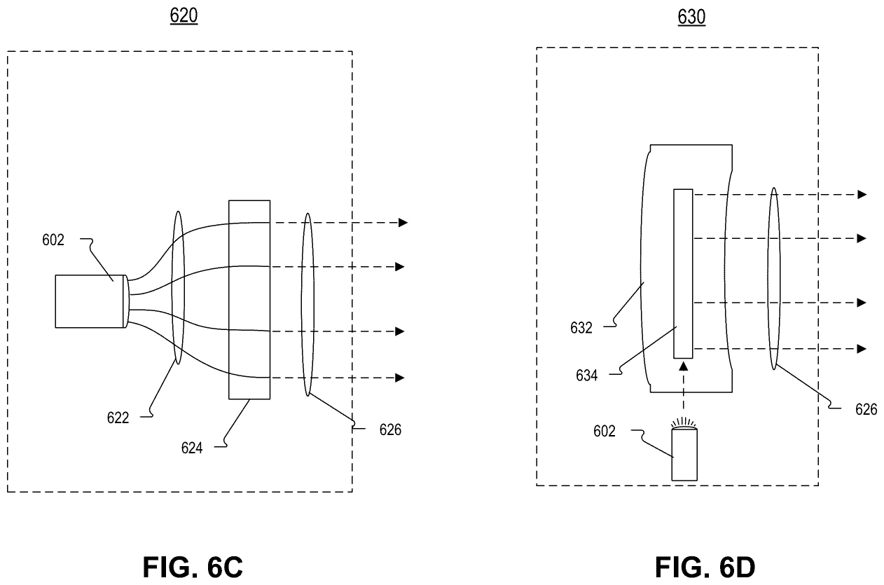

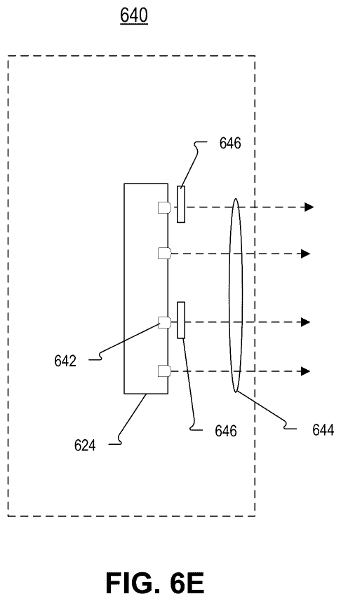

FIGS. 6A, 6B, 6C, 6D, and 6E illustrate example diagrams of potential implementations of an interference pattern emitter, in accordance with aspects of the disclosure. FIG. 6A illustrates a diagram of an interference pattern emitter 600, in accordance with aspects of the disclosure. Interference pattern emitter 600 includes a light source 602 optically coupled to a diffractive optical element 604. Light source 602 is configured to provide a light beam 606 to diffractive optical element 604. Diffractive optical element 604 is configured to transform light beam 606 into multiple (e.g., three or more) light beams that can predictably interfere to provide interference light patterns, according to an embodiment. Diffractive optical element 604 may be implemented as a spatial light modulator (SLM) or as a custom phase grating, for example. Diffractive optical element 604 may be configured to emit light beams 608A, 608B, 608C, and 608D (collectively, light beams 608), according to an embodiment. Although four light beams are illustrated as an example, fewer than four or more than four light beams may be used, according to various embodiments of the disclosure. Light beams 608 are configured to constructively and destructively interfere to generate a number of spatial carrier frequencies on a surface (e.g., an eye) that is within an eyebox region. Diffractive optical element 604 may be configured to manipulate the phase of one or more light beams 608, so that all of light beams 608 are out of phase with one another, according to an embodiment. Diffractive optical element 604 may be configured to manipulate the phase of one or more light beams 608, so that some of light beams 608 are out of phase with some of the others of light beams 608, according to an embodiment.

FIG. 6B illustrates a diagram of an interference pattern emitter 610 that is configured to provide an interference pattern into an eyebox region, in accordance with aspects of the disclosure. Interference pattern emitter 610 includes light source 602 optically coupled to a diffractive optical element 612, according to an embodiment. Diffractive optical element 612 may be implemented as an SLM or as a custom phase grating, for example. Diffractive optical element 612 may be configured to direct light beams 614A, 614B, 614C, and 614D (collectively, light beams 614) at angles (e.g., angles θA and OB) with respect to an output surface of diffractive optical element 612. By emitting light beams 614 at various angles, additional spatial frequency carriers may be generated in the interference light patterns, which may create unique or identifiable artifacts or sub-patterns to facilitate detection of relative and absolute eye position, according to embodiments of the disclosure.

FIG. 6C illustrates a diagram of an interference pattern emitter 620 that is configured to provide interference patterns, in accordance with aspects of the disclosure. Interference pattern emitter 620 includes light source 602 that is optically coupled to a number of fiber optical elements 622 to provide an interference light pattern, according to an embodiment. Fiber optical elements 622 may be coupled to a portion of a frame 624 of, for example, a head-mounted device. Fiber optical elements 622 may be positioned at a number of different locations around, for example, a lens assembly to direct light into the eyebox region from a number of different directions to generate particular interference patterns. Fiber optical elements 622 may emit light beams 626 orthogonally or at various angles from frame 624, according to embodiments of the disclosure.

FIG. 6D illustrates a diagram of an interference pattern emitter 630 that is configured to provide interference patterns from a (transparent) lens assembly 632, in accordance with aspects of the disclosure. Interference pattern emitter 630 includes light source 602 that is optically coupled to a waveguide 634. Waveguide 634 may be carried within or on lens assembly 632. Waveguide 634 may be included in an illumination layer of a lens assembly stack. Waveguide 634 may include one or more phase gratings or other diffractive features (e.g., holographic optical element) to emit light beams 626 towards an eyebox region. Alternatively, interference pattern emitter 630 may include two orthogonal photonic integrated circuits implemented as miniature laser-written waveguides with waveguide projectors having two or more light sources to generate multiple carrier frequencies in the interference pattern.

FIG. 6E illustrates a diagram of an interference pattern emitter 640 that is configured to provide an interference pattern having various overlapping and non-interfering light patterns, in accordance with aspects of the disclosure. Interference pattern emitter 640 includes a number of light sources 642 coupled to frame 624 and configured to emit light beams 644. Light sources 642 may be implemented as VCSELs or another type of laser. Two or more of light sources 642 may be optically coupled to polarizers 646 to provide interference light patterns having a first polarity and a second polarity that do not interfere. Polarizers 646 may be implemented as a quarter waveplate, a half waveplate, or some other polarization shifting element. Polarizers 646 may be made of birefringent materials such as quartz, organic material sheets, or liquid crystal, for example. Interference pattern detectors may include birefringent materials and/or other polarizers selectively positioned over one or more photodiodes or pixels to enable the detection of various polarized interference patterns.

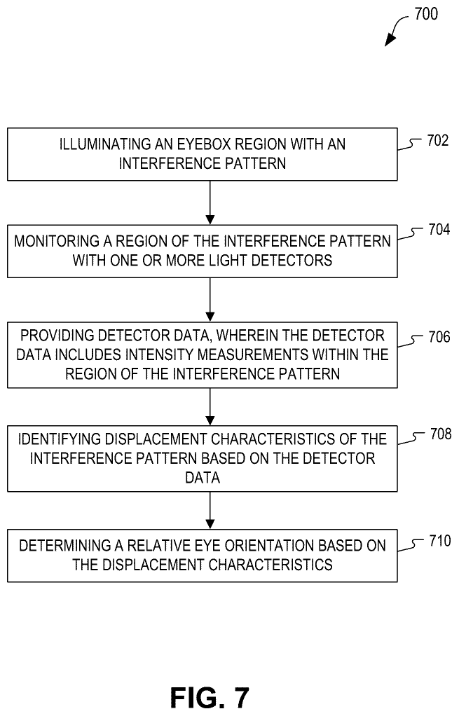

FIG. 7 illustrates a flow diagram of a process 700 for determining eye position with a head-mounted device, in accordance with aspects of the disclosure. Process 700 may be at least partially incorporated into or performed by an eye tracking system, according to an embodiment. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel.

At process block 702, process 700 includes illuminating an eyebox region with an interference pattern, according to an embodiment. Process block 702 proceeds to process block 704, according to an embodiment.

At process block 704, process 700 includes monitoring a region of the interference pattern with one or more light detectors, according to an embodiment. Process block 704 proceeds to process block 706, according to an embodiment.

At process block 706, process 700 includes providing detector data, wherein the detector data includes intensity measurements within the region of the interference pattern, according to an embodiment. Process block 706 proceeds to process block 708, according to an embodiment.

At process block 708, process 700 includes identifying displacement characteristics of the interference pattern based on the detector data, according to an embodiment. Process block 708 proceeds to process block 710, according to an embodiment.

At process block 710, process 700 includes determining a relative eye orientation based on the displacement characteristics, according to an embodiment. The relative eye orientation may include an angle of rotation, a rate of rotation, and/or a direction of rotation.

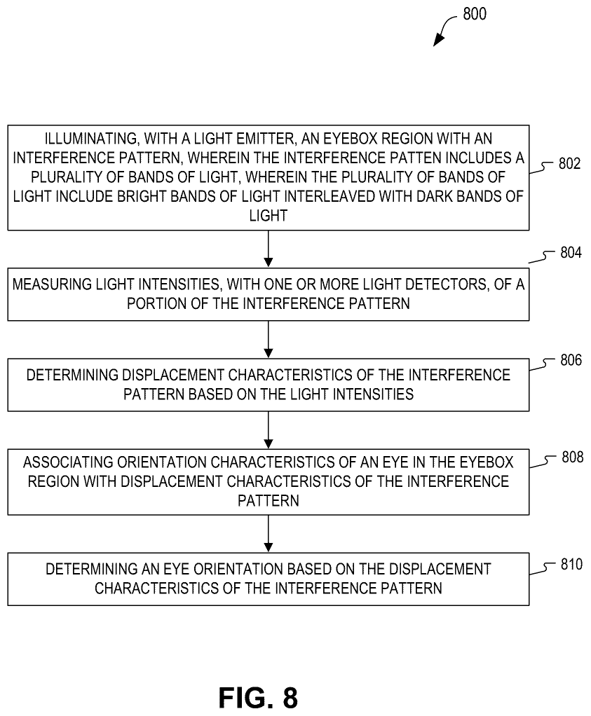

FIG. 8 illustrates a flow diagram of a process 800 for determining eye position with a head-mounted device, in accordance with aspects of the disclosure. Process 800 may be at least partially incorporated into or performed by an eye tracking system, according to an embodiment. The order in which some or all of the process blocks appear in process 800 should not be deemed limiting. Rather, one of ordinary skill in the art having the benefit of the present disclosure will understand that some of the process blocks may be executed in a variety of orders not illustrated, or even in parallel.

At process block 802, process 800 includes illuminating, with a light emitter, an eyebox region with an interference pattern, wherein the interference pattern includes a plurality of bands of light, wherein the plurality of bands of light include bright bands of light interleaved with dark bands of light, according to an embodiment. Process block 802 proceeds to process block 804, according to an embodiment.

At process block 804, process 800 includes measuring light intensities, with one or more light detectors, of a portion of the interference pattern, according to an embodiment. Process block 804 proceeds to process block 806, according to an embodiment.

At process block 806, process 800 includes determining displacement characteristics of the interference pattern based on the light intensities, according to an embodiment. The displacement characteristics may include a displacement distance of the interference pattern, an angle of displacement of the interference pattern, a distance displacement rate of the interference pattern, and/or an angular rate of displacement of the interference pattern. Process block 806 proceeds to process block 808, according to an embodiment.

At process block 808, process 800 includes associating orientation characteristics of an eye in the eyebox region with displacement characteristics of the interference pattern, according to an embodiment. The orientation characteristics of the eye may include a relative orientation, an angle of rotation, an angular rate of rotation, and/or a direction of rotation. The processing logic circuitry or memory circuitry includes a table or other data structure that associates orientation characteristics with displacement characteristics, according to an embodiment. Process block 808 proceeds to process block 810, according to an embodiment.

At process block 810, process 800 includes determining an eye orientation based on the displacement characteristics of the interference pattern, according to an embodiment. The eye orientation may include an angle of rotation, a rate of rotation, and/or a direction of rotation.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” (e.g., 128) in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” (e.g., 130) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A network may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), FC (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An eye tracking system for a head-mounted device comprising:
an emitter that provides at least two light beams that combine to provide a light pattern in an eyebox region of the head-mounted device, wherein the light pattern includes an interference pattern based on constructive and destructive interference of the at least two light beams;
a light detector oriented towards the eyebox region and configured to detect a portion of the light pattern, wherein the light detector provides detector data that is representative of one or more light intensities in the portion of the light pattern; and
processing logic coupled to the light detector to receive the detector data, wherein the processing logic is configured to identify displacement characteristics of the interference pattern based on the detector data, wherein the processing logic is configured to determine orientation characteristics of an eye in the eyebox region based on the displacement characteristics.

2. The eye tracking system of claim 1, wherein the interference pattern includes bands of light, wherein the bands of light include bright bands of light interleaved with dark bands of light, wherein the bands of light are periodic and have a period, wherein the processing logic is configured to count a number of full periods of displacement of the bands of light to determine the displacement characteristics.

3. The eye tracking system of claim 1, wherein the light detector includes a photodiode array having a plurality of photodiodes arranged in a line, wherein the interference pattern is sinusoidal, wherein the photodiode array is configured to detect displacement characteristics in one direction.

4. The eye tracking system of claim 1, wherein the emitter includes at least one coherent light source, wherein the emitter is configured to emit two or more beams of light that interfere to generate the interference pattern.

5. The eye tracking system of claim 1, wherein the processing logic includes a table or data structure to associate displacement characteristics of the interference pattern with orientation characteristics of an eye in the eyebox region.

6. The eye tracking system of claim 1, wherein the displacement characteristics include at least one of a displacement distance of the interference pattern, a displacement rate of the interference pattern, or a displacement direction.

7. The eye tracking system of claim 1, wherein the orientation characteristics of the eye include at least one of a relative orientation, an angle of rotation, an angular rate of rotation, or a direction of rotation.

8. The eye tracking system of claim 1, wherein the interference pattern is a fringe pattern that includes a plurality of bands of light, wherein the plurality of bands of light shift in the interference pattern based on characteristics of the emitter, wherein characteristics of the emitter include at least one of: a distance from the eyebox region, a wavelength of the at least two light beams, or an exit angle of the at least two light beams.

9. The eye tracking system of claim 1, wherein the light detector includes an image sensor that is de-focused with respect to the eyebox region and that is configured to include image data in the detector data, wherein the interference pattern includes one or more artifacts, wherein the processing logic is configured to determine an absolute orientation of the eye based on a location of the one or more artifacts in the image data.

10. The eye tracking system of claim 1, wherein the at least two light beams include four light beams, wherein one or more phases of the four light beams are mismatched to generate a custom two-dimensional (2D) interference pattern.

11. The eye tracking system of claim 1, wherein the emitter includes at least one polarizer configured to change a polarity of one or more of the at least two light beams.

12. The eye tracking system of claim 1, wherein the one or more of the at least two light beam are frequency chirped to generate custom unambiguous modulation in the interference pattern.

13. The eye tracking system of claim 1, wherein the at least two light beams have near-infrared spectrum wavelengths.

14. The eye tracking system of claim 1, wherein the interference pattern includes at least two orthogonal sinusoidal patterns, wherein the light detector includes a first photodiode array and a second photodiode array oriented orthogonally to the first photodiode array, wherein the light detector is configured to detect the displacement characteristics in at least two directions.

15. The eye tracking system of claim 1, wherein the emitter is configured to encode information with frequency or phase modulation of the at least two light beams, wherein the processing logic is configured to extract the information to improve a signal-to-noise ratio of the displacement characteristics.

16. A method of determining eye position with a head-mounted device comprising:
illuminating, with a light emitter, an eyebox region with an interference pattern, wherein the interference pattern includes a plurality of bands of light, wherein the plurality of bands of light include bright bands of light interleaved with dark bands of light;
measuring light intensities, with one or more light detectors, of a portion of the interference pattern;
determining displacement characteristics of the interference pattern based on the light intensities;
associating orientation characteristics of an eye in the eyebox region with displacement characteristics of the interference pattern; and
determining an eye orientation based on the displacement characteristics of the interference pattern.

17. The method of claim 16, wherein the eye orientation includes at least one of a position relative to the one or more light detectors, an angle of rotation, a rate of rotation, and/or a direction of rotation,
wherein the plurality of bands of light are periodic and have a period, wherein determining displacement characteristics includes counting a number of full periods of displacement of the plurality of bands of light to determine the displacement characteristics.

18. A method of determining eye position with a head-mounted device comprising:
illuminating, with a light emitter, an eyebox region with an interference pattern;
monitoring, with one or more light detectors, a region of the interference pattern;
providing detector data, wherein the detector data includes intensity measurements within the region of the interference pattern;
identifying displacement characteristics of the interference pattern based on the detector data; and
determining a relative eye orientation based on the displacement characteristics.

19. The method of claim 18, wherein the interference pattern includes, wherein the displacement characteristics include at least one of a displacement distance of the interference pattern, a displacement rate of the interference pattern, or a displacement direction of the interference pattern.

20. The method of claim 18 further comprising:
mapping eye orientation changes to the displacement characteristics, wherein the displacement characteristics are at least partially based on characteristics of the light emitter.
